(19) United States
(12) Patent Application Publication
(10) Pub. No.: US 2026/0023168 A1
(43) Pub. Date: Jan. 22, 2026

(54) GEDI CANOPY HEIGHT CORRECTION METHOD CONSIDERING TWOFOLD INFLUENCE OF TOPOGRAPHY

(71) Applicant: WUHAN UNIVERSITY, Hubei (CN)

(72) Inventors: Zhaocong WU, Hubei (CN); Zhixiong DAI, Hubei (CN); Ruixin FANG, Hubei (CN); Keyi RAO, Hubei (CN); Haoyu LIN, Hubei (CN)

(73) Assignee: WUHAN UNIVERSITY, Hubei (CN)

(21) Appl. No.: 19/273,026

(22) Filed: Jul. 17, 2025

(30) Foreign Application Priority Data
Jul. 18, 2024 (CN) 202410966998.4

(51) Int. Cl. G01S 7/497; G01S 7/487; G01S 17/89; G06N 20/20

(52) U.S. Cl. CPC G01S 7/497; G01S 7/487; G01S 17/89; G06N 20/20

(57) ABSTRACT

The disclosure provides an improved canopy height correction method. The method includes: obtaining GEDI LiDAR data, airborne canopy height data, GDEM with high resolution and land cover product within the selected target area and timeframe; performing quality filtering and spatial-scale filtering on GEDI footprints; extracting laser pointing parameters and waveform parameters; extracting reference canopy height from airborne data for each footprint; extracting laser pointing parameters and waveform parameters; preprocessing the GDEM and calculating topographic parameters, including topographic variability index (TVI); constructing the Laser Pointing and Topographic Index (LPTI) according to the 3D forest-ground geometry model; inputting the waveform parameters, even topographic parameters, TVI and LPTI as independent variables, and the reference canopy height as the dependent variable to modeling an improved forest canopy height extraction, and utilizing the improved canopy height extraction model to correct the twofold influence of topographic on GEDI canopy height extraction.

### CROSS-REFERENCE TO RELATED APPLICATION

This application claims priority to Chinese Patent Application No. 202410966998.4, filed on Jul. 18, 2024. The entirety of the above-mentioned patent applications is hereby incorporated by reference herein and made a part of this specification.

### BACKGROUND

The disclosure relates to the field of full-waveform LiDAR processing technology, and in particular to an improved GEDI Canopy height correction method considering topographic influence duality.

NASA's Global Ecosystem Dynamics Investigation (GEDI) spaceborne LiDAR mission, which was successfully launched on the 5^{th} December 2018, will make near global measurements of the Earth's land surface with the orbital bounds of the International Space Station (51.6° N-51.6° S). The primary objective of GEDI is to assess forest resources and enhance scientific understanding of carbon and water cycle dynamics, as well as biodiversity. To achieve this, GEDI employs a 25 m footprint resolution and operates at a wavelength of 1064 nm, where vegetation exhibits the highest reflectance. The GEDI instrument consists of 3 lasers producing a total 8 beam ground transects. Compared to the Single-Photon LiDAR and Discrete Return LiDAR, full-waveform LiDAR carried by GEDI has been widely used in research on forest height, biomass, carbon stock estimation and understory terrain detection due to its strong penetration capability.

Topography is one of the main factors affecting the estimation accuracy of the GEDI canopy height. Study finds the topography affect GEDI forest canopy height estimation in two aspects. Firstly, the laser transmitted by laser altimeter system is at an angle of 0-6° to the normal of the horizontal plane, resulting the difference between the vertical canopy height and detected canopy height. According to the theoretical derivations of 2D forest-ground geometry model, shown in FIG. 1, the ratio of the detected canopy height and the vertical canopy height decreases from 1 as the slope increases from 0 to 90. The result indicates that the steep terrain may lead to an underestimation of canopy height. Additionally, the receive waveform of GEDI is also affected by the topography. When the ground is flat, width of the ground waveform is related to the width of the GEDI transmit waveform. As the ground becomes steeper, the width of the ground echo increases, leading to an overestimation of the canopy height, shown as FIG. 2. Furthermore, in some extremely steep areas, the ground waveform can even mix completely with canopy waveform, thus reducing accuracy of canopy height extraction.

Nowadays, researchers have evaluated the influence of topography on GEDI canopy height, but none of them have simultaneously considered and attempted to correct the twofold influence of the topography. In addition, the most correction methods assume that the slope remains uniform within the GEDI footprint, estimating the canopy height by introducing the mean topography parameters. However, the GEDI footprint has a radius of 12.5 m so that the topographic elements within it are usually uneven, especially in mountainous regions or tropical rainforests. Therefore, it is necessary to propose a method that accounts for the coupling effect of laser orientation and topography, as well as the impact of topographic unevenness on GEDI ground waveforms, to improve the accuracy of the canopy height estimation.

### SUMMARY

For the problems in the prior arts, the disclosure provides an improved method for GEDI canopy height correction, considering twofold influence of topography and utilizing GDEM with high resolution to express the topographic unevenness for improving the accuracy of GEDI canopy height.

In order to address the above technical problem, the disclosure provides the following technical solution: improved GEDI canopy height correction method considering twofold influence of topography, which includes the following steps.

S1, obtaining GEDI LiDAR data at a L1B level and a L2A level of a target area within a specified time, and obtaining an airborne canopy height data and auxiliary data of the target area, wherein the auxiliary data comprises ALOS DEM topographic data with a spatial resolution of 12.5 m and land cover data;

S2, performing footprint quality filtering on the obtained GEDI LiDAR data at the LIB level and the L2A level, then performing a spatial-scale filtering on the obtained GEDI LiDAR data at the L1B level and the L2A level in combination with the land cover data to obtain high-quality footprints within a forest area, and forming GEDI footprints;

S3, extracting laser pointing parameters, canopy waveform parameters and ground waveform parameters of the GEDI footprints, and extracting the GEDI footprint-level airborne canopy height based on geo-location information of the GEDI footprints;

S4, preprocessing the ALOS DEM topographic data with the resolution of 12.5 m, generating slope, aspect, roughness based on the geo-location information of the GEDI footprints, using inverse distance weighting interpolation method to obtain slope, aspect, and roughness of four theoretical pixels within the footprints, and obtaining a topographic variability index by calculating a slope variance based on the slope, the aspect and the roughness of the four theoretical pixels within the footprints, wherein the topographic variability index is used to characterize a change of the slope within the footprints, wherein the slope, the aspect, the roughness and the topographic variability index of the four theoretical pixels within the footprints constitute topographic parameters;

S5, constructing LPTI coupling index based on the laser pointing parameters extracted from the GEDI footprints and the slopes and the aspects of the four theoretical pixels within the footprints according to a GEDI LiDAR transmission geometrical model;

S6, inputting training data into a random forest regression model to construct a full-waveform LiDAR topographic correction model, wherein the random forest regression model uses the canopy waveform parameters and the ground waveform parameters, the LPTI coupling index, and the topographic parameters as independent variables, while the airborne canopy height is used as dependent variables.

S7, obtaining topographically-corrected canopy height by inputting the canopy waveform parameters and the ground waveform parameters extracted from the GEDI footprints, the constructed topographic parameters, and the constructed LPTI coupling index into the full-waveform LiDAR topographic correction model,
wherein the LPTI coupling index constructed in the step S5 is:

$$LPTI = \frac{1}{n} {\sum }_{i = 0} ( sin ( α ) cos ( {θ}_{i} ) tan ( {η}_{i} ) - cos ( α ) )$$

wherein ηᵢ is a slope of the i-th theoretical pixel, θᵢ is a smaller angle between the aspect and a laser azimuth, n is a number of the theoretical pixels, a is a laser elevation angle.

In some embodiments, step S1 comprises:
obtaining a latitude range and a longitude range of the target area;
obtaining the airborne canopy height data for the target area;
obtaining the L1B level and the L2A level GEDI LiDAR data within the latitude range and the longitude range of the target area, with a data release time and an airborne canopy height data generation time being in a same year;
obtaining the auxiliary data within the target area, comprising the ALOS DEM data with the spatial resolution of 12.5 m and ESA land cover data with a spatial resolution of 10 m.

In some embodiments, step S2 comprises:
performing data filtering on the L1B level and the L2A level GEDI LiDAR data based on footprint quality to remove GEDI footprint data with errors;
performing spatial-scale filtering on the GEDI LiDAR data according to the land cover data to obtain high-quality footprints within the forest area, which specifically comprises: constructing a simulated footprint surface with longitude and latitude contained in the geo-location information of the footprints as the center and a radius of 12.5 m, then by using a forest mask product of a research area as cropping range data, and using simulated footprint vector as to-be-processed data, performing cropping operation, wherein the area represented by each footprint after cropping is the forest area covered by the GEDI footprint; based on a longitude and latitude belt where the research area is located, projecting the cropped footprint vector data by a WGS 1984 ellipsoidal coordinate system to a Gauss-Krüger projection coordinate system of a corresponding indexing belt; and then calculating each footprint vector area in batches, wherein a ratio of the footprint vector area to an area of a circle with an original radius of 12.5 m is a forest cover rate of the footprint, which is calculated as below:

$$FC = \frac{{Area}_{ESA}}{π \times {12.5}^{2}}$$

wherein FC is the forest cover rate of the footprint, and Area_{ESA} is the cropped footprint vector area;
after filtering out the GEDI footprints with the forest cover rate lower than a preset rate, extracting footprint numbers of all high-quality forest footprints to form GEDI footprints. In some embodiments, step S3 comprises:
based on numbers of the high-quality footprints of the forest area extracted in step S2, extracting the laser pointing parameters of the screened footprints from the L1B level GEDI LiDAR data, comprising a beam pointing azimuth and a beam pointing elevation angle;
based on the numbers of the high-quality footprints of the forest area extracted in step S2, extracting the geo-location information of the footprints from the L2A level GEDI LiDAR data, comprising a latitude of a lowest detected mode and a longitude of the lowest detected mode; based on the latitude and longitude of the lowest detected mode of the footprints, extracting an average airborne canopy height for each footprint to obtain the footprint-level airborne canopy height;
extracting the canopy waveform parameters from the L1B level and the L2A level GEDI LiDAR data, wherein the canopy waveform parameters specifically comprise: height quantiles and waveform range; extracting the ground waveform parameters from the L2A level GEDI LiDAR data, wherein the ground waveform parameters specifically comprise: an amplitude of the lowest detected mode and an energy of the lowest detected mode.

In some embodiments, extracting the canopy waveform parameters from the L1B level and the L2A level GEDI LiDAR data comprises:
performing sampling on the height quantiles rh of the L2A level GEDI LiDAR data and extracting a preset number of height quantile indexes;
extracting parameter indexes for calculating the waveform range from the L1B level GEDI LiDAR data and substituting the parameter indexes into the following formula to calculate the waveform range:

$${W}_{ext} = \frac{botloc - toploc}{rx\_sample \_count} \times ( elevation\_bin0 - elevation\_lastbin )$$

wherein Wₑₓₜ is a waveform range, botloc is an energy index of the lowest detected mode, toploc is an energy index of a highest detected mode, elevation_bin0 is a start elevation of a waveform window, elevation_lastbin is an ending elevation of the waveform window, rx_sample_count is an interval number of waveform sampling.

In some embodiments, step S4 comprises:
for the ALOS DEM topographic data with the resolution of 12.5 m, using dynamic window method to construct a calculation window for each pixel, and generating slopes, aspects and roughness of a central pixel and neighboring pixels in the window according to the following formula:

$$Slope = \frac{180}{π} \times arctan ( \sqrt{{( \frac{dh}{dx} )}^{2} + {( \frac{dh}{dy} )}^{2}} )$$

$$Aspect = \frac{180}{π} \times arctan ( \frac{dz / dy}{- dz / dx} )$$

$$Roughness = \sqrt{\frac{\sum H ( j )}{N - 1}}$$

wherein Slope is a slope value of a central point of the window, Aspect is an aspect value of the central point of the window, Roughness is a roughness value of the central point of the window, and dh/dx and dh/dy are elevation change rates of X and Y directions respectively, H(j) is a j-th pixel elevation value within the window, wherein 0<j<4, and N is a number of pixels within the window;
determining coordinates of centers of the four theoretical pixels contained in the footprints based on the position of the center of the GEDI footprints and the projection information contained in the ALOS DEM topographic data with the spatial resolution of 12.5 m; using inverse distance weighting interpolation method to obtain ALOS topographic feature group within GEDI 25 m footprints, and calculating an in-group variance to extract the topographic variability index, based on the following formula:

$${T}_{v ar} = \sqrt{\frac{\sum {( {Slope}_{1} - {Slope}_{avg} )}^{2}}{n}}$$

wherein Slopeᵢ is a slope value of the theoretical pixels, Slope_{avg} is a slope average of the four theoretical pixels corresponding to the footprints, n is a number of the theoretical pixels.

In some embodiments, step S6 comprises:
carrying out random sampling in each sub-segment based on a slope distribution; dividing research data into two portions of 80% and 20%, wherein the 80% portion is used as training data and the 20% portion is used as validation data; inputting canopy waveform parameters, ground waveform parameters, topographic parameters, LPTI coupling indexes of the training data as independent variables and the airborne canopy height as dependent variable into the random forest regression model; performing training and parameter optimization on the random forest regression model to obtain the full-waveform LiDAR topographic correction model;
inputting the test data into the full-waveform LiDAR topographic correction model and using an output result as a topographically-corrected GEDI canopy height.

In some embodiments, the method further comprises:
using 99% of height quantiles extracted in step S3 as a GEDI canopy height before topographic correction; using linear fitting to calculate relevance, deviation, standard deviation of the GEDI canopy height and the airborne canopy height before and after topographic correction, and further evaluating an availability of the GEDI LiDAR topographic correction model.

In some embodiments, the canopy waveform parameters input in step S7 comprises height quantiles and waveform range, and the ground waveform parameters comprise the amplitude of the lowest detected mode and the energy of the lowest detected mode.

Compared with the prior arts, the disclosure has the following beneficial effects.

The improved GEDI canopy height correction method considering twofold influence of topography provided in this disclosure, designed a laser pointing and topography index (LPTI) based on the 3D forest-ground geometry model, which represents the scaling factor between the detected canopy height and the vertical canopy height, enhancing the resistance of the canopy height extraction model to the coupling influence of laser orientation and topography.

The improved GEDI canopy height correction method considering twofold influence of topography provided in this disclosure, utilize GDEM with high resolution to capture topography unevenness within the GEDI footprint with resolution of 25 m. The topography variability index (TVI) is designed and introduced into the random forest model, enhancing the resistance of the canopy height extraction model to the influence of topography unevenness.

### BRIEF DESCRIPTIONS OF THE DRAWINGS

FIG. 1 is a flowchart illustrating the improved GEDI canopy height correction method considering twofold influence of topography provided in this disclosure.

FIG. 2 is a schematic diagram of 2D forest-ground geometry model, showing the geometric relation between detected canopy height and vertical canopy height while the laser azimuth is equal to aspect.

FIG. 3 is a schematic diagram illustrating the influence of the broaden effect of terrain on waveforms under constant ground and canopy elevation.

FIG. 4 is a schematic diagram of 3D forest-ground geometry model, showing the geometric relation between detected canopy height and vertical canopy height.

FIG. 5 is a schematic diagram of GEDI footprints in zunyi regions, Guizhou province of China.

FIG. 6 is a scatter plot illustrating GEDI canopy height data after topographic correction (x) and reference canopy height data obtained from airborne LiDAR (y).

### DETAILED DESCRIPTIONS OF EMBODIMENTS

The disclosure provides an improved method for GEDI canopy height correction, considering twofold influence of topography. The following further describes the technical solution of the disclosure with reference to the airborne forest height map of the zunyi region, Guizhou province of China in 2020 and a random forest model constructed by python, and in combination with accompanying drawings and embodiments.

The technical solution of the embodiments of the disclosure will be fully and clearly described in combination with the embodiments of the disclosure.

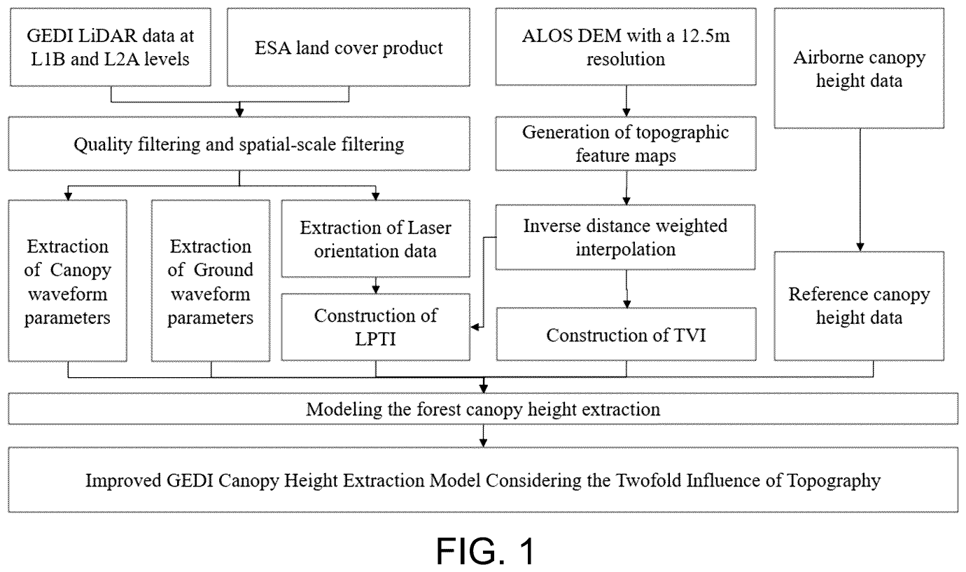

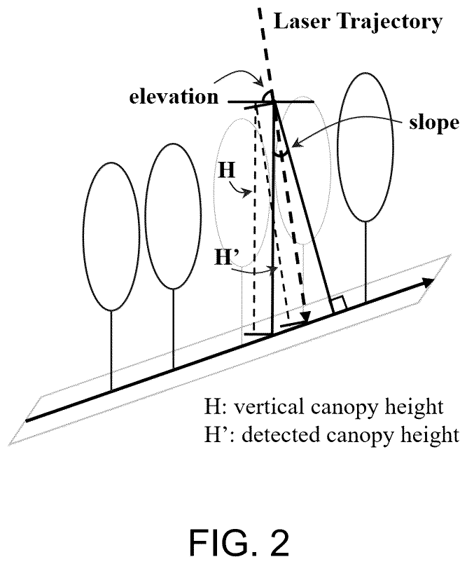

The GEDI canopy height correction method of the twofold influence of the topography proposed in this disclosure, as shown in FIG. 1, comprises the following steps.

S1, obtaining GEDI LiDAR data at a L1B level and a L2A level of a target area within a specified time, and obtaining an airborne canopy height data and auxiliary data of the target area, wherein the auxiliary data comprises ALOS DEM topographic data with a spatial resolution of 12.5 m and land cover data.

By following S1, ensuring the spatiotemporal consistency of multi-source remote sensing data.

S2, performing footprint quality filtering on the obtained GEDI LiDAR data at the LIB level and the L2A level, then performing a spatial-scale filtering on the obtained GEDI LiDAR data at the L1B level and the L2A level in combination with the land cover data to obtain high-quality footprints within a forest area, and forming GEDI footprints.

By following S2, filtering out footprints with low quality and forest cover, and correcting the overall error in canopy height.

S3, extracting laser pointing parameters, canopy waveform parameters and ground waveform parameters of the GEDI footprints, and extracting the GEDI footprint-level airborne canopy height based on geo-location information of the GEDI footprints.

By following S3, basic GEDI parameters and reference canopy height are collected for each footprint.

S4, preprocessing the ALOS DEM topographic data with the resolution of 12.5 m, generating slope, aspect, roughness based on the geo-location information of the GEDI footprints, using inverse distance weighting interpolation method to obtain slope, aspect, and roughness of four theoretical pixels within the footprints, and obtaining a topographic variability index by calculating a slope variance based on the slope, the aspect and the roughness of the four theoretical pixels within the footprints, wherein the topographic variability index is used to characterize a change of the slope within the footprints, wherein the slope, the aspect, the roughness and the topographic variability index of the four theoretical pixels within the footprints constitute topographic parameters.

By following S4, the topographic parameters are calculated to represent the topographic features of each footprint, especially the unevenness of the terrain.

S5, constructing LPTI coupling index based on the laser pointing parameters extracted from the GEDI footprints and the slopes and the aspects of the four theoretical pixels within the footprints according to a GEDI LiDAR transmission geometrical model.

By following S5, representing the coupling influence of laser orientation and topography to canopy height estimation.

S6, inputting training data into a random forest regression model to construct a full-waveform LiDAR topographic correction model, wherein the random forest regression model uses the canopy waveform parameters and the ground waveform parameters, the LPTI coupling index, and the topographic parameters as independent variables, while the airborne canopy height is used as dependent variables.

By following S6, enhancing the resistance of the canopy height extraction model to the coupling influence of the laser orientation and topography and the topography unevenness.

S7, obtaining topographically-corrected canopy height by inputting the canopy waveform parameters and the ground waveform parameters extracted from the GEDI footprints, the constructed topographic parameters, and the constructed LPTI coupling index into the full-waveform LiDAR topographic correction model.

By following S7, achieving GEDI canopy height correction of the twofold topographic influence for the target footprint.

The improved GEDI canopy height correction method considering twofold influence of topography provided in this disclosure, designed a laser pointing and topography index (LPTI) based on the 3D forest-ground geometry model, which represents the scaling factor between the detected canopy height and the vertical canopy height, enhancing the resistance of the canopy height extraction model to the coupling influence of laser orientation and topography.

The improved GEDI canopy height correction method considering twofold influence of topography provided in this disclosure, utilize ALOS DEM with a resolution of 12.5 m to capture topography unevenness within the GEDI footprint with resolution of 25 m. The topography variability index (TVI) is designed and introduced into the random forest model, enhancing the resistance of the canopy height extraction model to the influence of topography unevenness.

GEDI (Global Ecosystem Dynamics Investigation) is a NASA mission designed to study Earth's forests and ecosystems using spaceborne LiDAR (light detection and ranging) technology. The GEDI includes multiple data products, which are classified into four levels: L1, L2, L3, and L4. This study primarily utilizes L1B and L2A level data. The L1 level products consist of geolocated GEDI waveform data. The L2 level products provide canopy height and profile metrics at the footprint scale.

Airborne canopy height map with high resolution were generated by processing LiDAR point clouds collected using an unmanned aerial vehicle (UAV). The drone-based remote sensing system acquired high-resolution 3D point cloud data, which were then classified and processed to extract a digital surface model (DSM) and a digital terrain model (DTM). Finally, a high-resolution canopy height map (CHM) was derived by subtracting the DTM from the DSM.

ALOS DEM (Advanced Land Observing Satellite Digital Elevation Model) is a global digital elevation model generated by the Japan Aerospace Exploration Agency (JAXA) using remote sensing data acquired from the ALOS (Advanced Land Observing Satellite) mission with a resolution of 12.5 m. ESA Land Use Data refers to global land cover and utilization information provided by the European Space Agency (ESA) through its Copernicus Programme, primarily derived from high-resolution observations by Sentinel satellites. This dataset continuously monitors surface changes at 10-20 meter resolution, covering various land types including forests, farmlands, and urban areas. It features three key advantages: open access (free availability), high update frequency (annual releases), and reliable accuracy.

In specific, S1 includes: S1.1, obtaining the LiDAR product at the L1B level and the L2A level of the target GEDI footprints and some used for training; S1.2, obtaining airborne canopy height data at a 1 m resolution containing the GEDI footprints used for training; S1.3, obtaining ALOS DEM data at a 12.5 m resolution covering all GEDI footprints; S1.4, obtaining ESA land cover products at a 10 m resolution covering all GEDI footprints.

In specific, S2 includes: S2.1, performing quality filtering on GEDI footprints; S2.2, performing spatial-scale filtering on GEDI footprints;
The step of performing quality filtering in S2.1 includes: setting footprint quality control criterions for filtering the footprints that does not meet the requirements or contains errors. The footprint quality control criterions are set as follows: the L2A quality control flag must be equal to 1, the return signal mustn't saturate, the waveform must detect the true ground level, the receive waveform must contain at least two modes, length of receive waveform must be between 3 and 100, and the difference between elevation of the lowest mode and GDEM must be less than 100 m.

The step of performing spatial-scale filtering in S2.2 includes: simulating the footprint area centered at the geo-location information of the footprints, with a radius of 12.5 m. Extracting the forest mask product from the ESA land cover product and computing its intersection with all footprint areas. Then, transforming the resulting shapefile from the WGS1984 Geographic Coordinate System (GCS) to the Projected Coordinate System (PCS) based on the geo-location of the research area for the calculation of forest area of each footprint. Finally, calculating the forest cover of each footprint by dividing forest area by the footprint area. The footprint area is equal to the area of a circle with radius 12.5 m. The footprints with less forest cover than 95% are considered non-forest footprints and then removed.

In specific, S3 includes: S3.1, extracting the laser pointing parameters and waveform parameters from GEDI products; S3.2, extracting the airborne canopy height data within each GEDI footprint as reference.

In specific, S3.1 includes: S3.11 extracting the laser pointing parameters; S3.12 extracting the canopy waveform parameters; S3.13 calculating the ground waveform parameters;
The step of extracting the laser pointing parameters in S3.11 includes: extracting the shot numbers of the high-quality footprints in forest area. Extracting the laser pointing parameters from GEDI L1B product according to the shot numbers, including local laser elevation and local laser azimuth.

The step of calculating the waveform parameters in S3.12 includes: extracting the basic parameters from GEDI product at L2A level for calculation of waveform parameters. All the extracted parameters are list in Table 1. Canopy waveform parameters consist of relative height metrics and parameters for waveform extent calculation. The waveform extent is calculated as follows:

$${W}_{ext} = \frac{botloc - toploc}{rx\_sample \_count} \times ( elevation\_bin0 - elevation\_lastbin )$$

TABLE 1
Summary of extracted parameters from GEDI
product at the L1B level and the L2A level.

| Product Level | Parameter Names | Description |
|---|---|---|
| L1B&L2A | shot_number | unique shot ID of each footprint |
| L2A | botloc | the energy index of the |
| | | lowest detected mode |
| L2A | toploc | the energy index of the |
| | | highest detected mode |
| L2A | elevation_bin0 | the start elevation of |
| | | the waveform window |
| L2A | elevation_lastbin | the ending elevation of |
| | | the waveform window |
| L2A | rx_sample_count | interval number of |
| | | waveform sampling |
| L2A | rh | height quantiles |
| L1B | local_beam_elevation | local laser elevation |
| L1B | local_beam_azimuth | local laser azimuth |

The step of extracting the ground waveform parameters in S3.13 includes: extracting the best algorithm index from GEDI L2A, the amplitude and energy of the lowest detected mode are extracted from GEDI L2A product according to the best algorithm index as ground waveform parameters.

The step of extracting the reference canopy height in S3.2 includes: extracting the longitude and latitude of the lowest detected mode from GEDI L1B product. Converting latitude and longitude of footprints to the PCS of the airborne canopy height data. Converting the obtained projected coordinates to pixel coordinates according to geo-transformation parameters of the airborne canopy height data. Using the obtained pixel coordinates as the center pixel, calculating the average value of all pixels whose centers are within a 12.5 m radius from the center pixel as the reference canopy height of the GEDI footprint.

In specific, S4 includes: S4.1, generating topographic feature maps; S4.2, calculating even topographic parameters; S4.3, calculating topographic variability index.

The step of generating topographic feature maps extraction in S4.1 includes: For the ALOS DEM with a resolution of 12.5 m, a dynamic window method is applied to construct a calculation window for each pixel. Based on the elevation values of the central pixel and its surrounding neighboring pixels within the window, the slope, aspect, and roughness of the central pixel are derived as follows:

$$Slope = \frac{180}{π} \times arctan ( \sqrt{{( \frac{dh}{dx} )}^{2} + {( \frac{dh}{dy} )}^{2}} )$$

$$Aspect = \frac{180}{π} \times arctan ( \frac{dz / dy}{- dz / dx} )$$

$$Roughness = \sqrt{\frac{\sum H ( j )}{N - 1}}$$

dh/dx, dh/dy is the elevation change rates of X and Y directions respectively, H(j) is the j-th pixel elevation value within the window, N is the number of the pixels within the window.

The step of calculating even topographic parameters in S4.2 includes: due the resolution of ALOS DEM is half that of GEDI footprint, each GEDI footprint encompasses four ALOS DEM pixels ideally. Firstly, the theoretical coordinates of the centers of theoretical pixels are determined according to the geo-location of GEDI footprint. Then, the inverse distance weighting (IDW) method is applied to interpolate the theoretical values of these pixels from the topographic feature maps. Finally, the mean slope, aspect and roughness are calculated by averaging the corresponding theoretical values of these pixels.

The step of topographic variability index calculation in S4.3 includes: calculating an in-group variance to extract the topographic variability index as follow based on the theoretical slopes of the theoretical pixels:

$${T}_{v ar} = \sqrt{\frac{\sum {( {Slope}_{1} - {Slope}_{avg} )}^{2}}{4}}$$

wherein Slopeᵢ is the slope value of the theoretical slope of ith pixel, Slope_{avg} represent the slope average of all theoretical slopes.

In specific, the construction of LPTI in S5 include: according to the 2D forest-ground geometry model, the geometric relation between vertical canopy height (H₀) and detected canopy height (H) is calculated as follows:

$$H = {H}_{0} * \frac{cos ( η )}{sin ( α + η )}$$

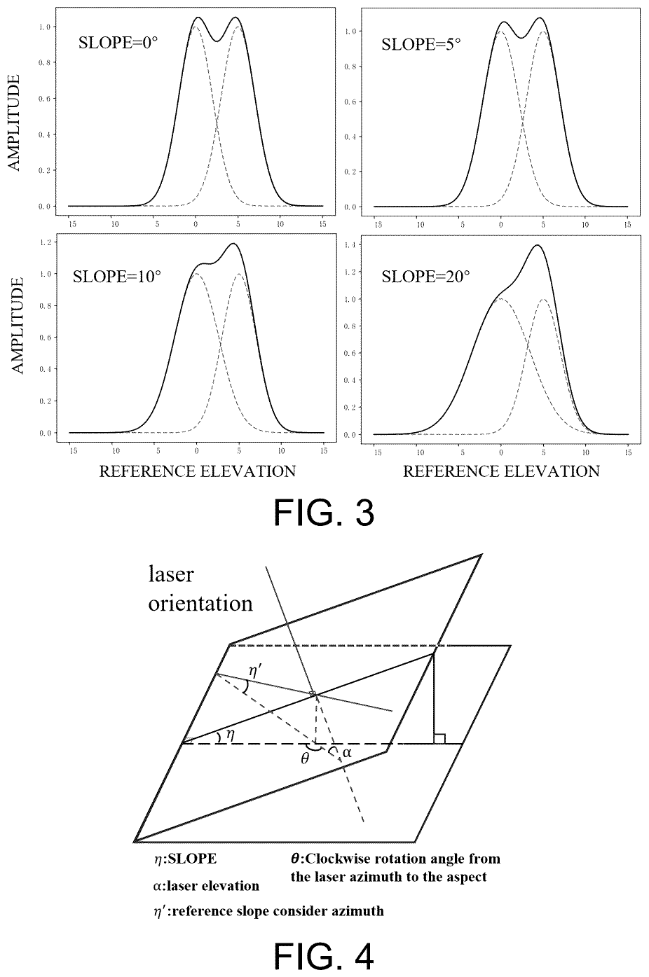

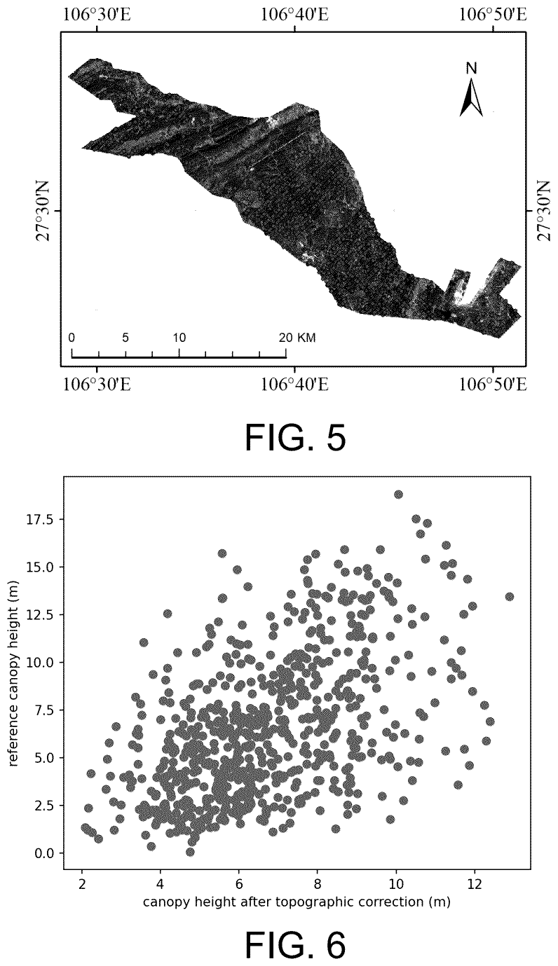

η is slope, α is laser elevation. However, model described above assumes that the laser azimuth is the same as the aspect. When the laser azimuth differs from the aspect, the model transitions from a 2D to a more complex 3D forest-ground geometry model, as shown in FIG. 3. In this model, the slope n can be substituted by η′, which represents the relative slope and is calculated as follows:

$$cot ( {η}^{′} ) * cos ( θ ) = cot ( η )$$

The geometric relation between vertical canopy height (H₀) and detected canopy height (H) is updated as follows:

$${H}_{0} = H * ( sin ( α ) cos ( θ ) tan ( η ) - cos ( α ) )$$

Finally, LPTI is calculated to represent the coupling effect of the laser orientation and topography as follows:

$$LPTI = \frac{1}{n} {\sum }_{i = 0} ( sin ( α ) cos ( {θ}_{i} ) tan ( {η}_{i} ) - cos ( α ) )$$

ηᵢ is a slope of the i-th theoretical pixel, θᵢ is the smaller angle between the aspect and the laser azimuth, n is the number of the theoretical pixels, α is the laser elevation angle.

In specific, S6 includes: S6.1, dividing the footprints into training set and validation dataset according to the slope distribution; S6.2, modeling the improved forest canopy height; S6.3, validating the improved forest canopy height.

The step of dividing the footprints into training set and testing set in S6.1 includes: gathering the slope distribution information of all footprints, and calculating their 20%, 40%, 60% and 80% percentiles based on the slope data. Splitting the footprints into five groups according to the calculated slope percentile, each representing a different range of slope. Afterwords, 20% of the footprints are randomly selected from each group to form the validation dataset. The remaining 80% of the footprints are used as the training dataset.

The step of modeling the improved forest canopy height in S6.2 includes: inputting canopy waveform parameters, ground waveform parameters, topography parameters, LPTI as independent variables, and airborne forest canopy height as the dependent variable to the random forest regression model. Train, optimize and validate the random forest regression model to obtain an improved canopy forest extraction model. The parameters input as independent variables are detailed in Table. 2.

TABLE 2
details of the independent variables for modeling

| type | parameters | Num |
|---|---|---|
| canopy waveform | relative height metrics(RHₙ{0 < n < | 12 |
| parameters | 100, step = 10}) | |
| | Waveform extent(Wₑₓₜ) | |
| Ground waveform | Amplitude of the lowest detected | 2 |
| parameters | mode(zcross_amp) | |
| | Energy of the lowest detected mode | |
| | (zcross_localenergy) | |
| Laser pointing | Laser Pointing and Topography Index(LPTI) | 1 |
| parameter | | |
| Topographic | Slope | 4 |
| parameters | Aspect | |
| | Roughness | |
| | Topographic Variability Index (TVI) | |

| | |
|---|---|
| total | 19 |

The step of validating the improved canopy height extraction model in S6.3 includes: inputting the test data into the full waveform LiDAR topography correction model to generate the GEDI forest canopy height after correction. Calculating the correlation, deviation, and standard deviation between the result and reference forest canopy height to evaluate the usability of the improved canopy height extraction model.

In specific, S7 includes, inputting the canopy waveform parameters, ground waveform parameters, laser pointing parameters and topographic parameters of target GEDI footprint into improved canopy height extraction model to output the canopy height unaffected by topography. The improved canopy height can be used to further improve the accuracy of subsequent forest parameters inversion, such as biomass, LAI and so on, and of the forest height maps by fusing together with the optical image.

All in all, this disclosure proposes am IMPROVED GEDI CANOPY HEIGHT CORRECTION METHOD CONSIDERING TWOFOLD INFLUENCE OF TOPOGRAPHY. The method includes: acquiring L1B and L2A level GEDI data, airborne forest canopy height data, high-resolution GDEM, and land cover data for the target area; performing quality filtering and spatial filtering to obtain highly reliable footprints; extracting laser pointing parameters, waveform parameters from GEDI product at L1B and L2A level; preprocessing the GDEM to calculate basic terrain features, including slope, aspect, and roughness, and extracting ALOS terrain feature sets within the GEDI footprint range using inverse distance weighted interpolation, further deriving terrain variability index (TVI) by calculating slope variance; based on the 3D forest-ground geometry model, constructing and calculating the LPTI using the footprint laser pointing parameters and topographic parameters; jointly establishing an improved canopy height extraction model using waveform parameters, laser pointing parameters and topographic parameters; calculating accuracy metrics for GEDI forest canopy height estimation before and after correction to further evaluate the usability of the terrain correction model. The disclosure considers the twofold influence of topography-namely, the coupling effect between terrain and laser orientation and the unevenness of topography within the footprint during canopy height estimation. It designs the LPTI based on the 3D forest-ground geometry model to characterize the coupling influence of t terrain and laser orientation. Additionally, given the 25 m resolution of GEDI footprints, the method utilizes 12.5 m ALOS DEM to construct a topography dataset, designing the TVI to represent topography unevenness. The developed LiDAR terrain correction model effectively mitigates the topographic influence in GEDI forest canopy height extraction.

Those skilled in the art should understand that the embodiments of the present invention may be provided as methods, systems, or computer program products. Accordingly, the present invention may take the form of an entirely hardware embodiment, an entirely software embodiment, or an embodiment combining both software and hardware aspects. Furthermore, the present invention may take the form of a computer program product implemented on one or more computer-usable storage media (including but not limited to disk storage, CD-ROM, optical storage, etc.) containing computer-usable program code.

The present invention is described with reference to flowchart illustrations and/or block diagrams of methods, apparatuses (systems), and computer program products according to embodiments of the invention. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, special-purpose computer, embedded processor, or other programmable data processing device to produce a machine, such that the instructions, when executed by the processor of the computer or other programmable data processing device, generate means for implementing the functions specified in one or more processes of the flowchart and/or one or more blocks of the block diagram.

While preferred embodiments of the present invention have been described, it will be understood by those skilled in the art that various modifications and adaptations may be made once they become aware of the basic inventive concepts. Accordingly, the appended claims are intended to be construed as encompassing the preferred embodiments and all alterations and modifications that fall within the scope of the invention. It will be apparent to those skilled in the art that various changes and modifications may be made to the embodiments of the present invention without departing from the spirit and scope thereof. Therefore, if such modifications and variations of the embodiments fall within the scope of the claims of the present invention and their equivalents, the present invention is also intended to cover these modifications and variations.

What is claimed is:

1. A GEDI canopy height correction method considering twofold influence of topography, comprising:
S1, obtaining GEDI LiDAR data at a L1B level and a L2A level of a target area within a specified time, and obtaining an airborne canopy height data and auxiliary data of the target area, wherein the auxiliary data comprises ALOS DEM topographic data with a spatial resolution of 12.5 m and land cover data;
S2, performing footprint quality filtering on the obtained GEDI LiDAR data at the L1B level and the L2A level, then performing a spatial-scale filtering on the obtained GEDI LiDAR data at the L1B level and the L2A level in combination with the land cover data to obtain high-quality footprints within a forest area, and forming GEDI footprints;
S3, extracting laser pointing parameters, canopy waveform parameters and ground waveform parameters of the GEDI footprints, and extracting the GEDI footprint-level airborne canopy height based on geo-location information of the GEDI footprints;
S4, preprocessing the ALOS DEM topographic data with the resolution of 12.5 m, generating slope, aspect, roughness based on the geo-location information of the GEDI footprints, using inverse distance weighting interpolation method to obtain slope, aspect, and roughness of four theoretical pixels within the footprints, and obtaining a topographic variability index by calculating a slope variance based on the slope, the aspect and the roughness of the four theoretical pixels within the footprints, wherein the topographic variability index is used to characterize a change of the slope within the footprints, wherein the slope, the aspect, the roughness and the topographic variability index of the four theoretical pixels within the footprints constitute topographic parameters;
S5, constructing LPTI coupling index based on the laser pointing parameters extracted from the GEDI footprints and the slopes and the aspects of the four theoretical pixels within the footprints according to a GEDI LiDAR transmission geometrical model;
S6, inputting training data into a random forest regression model to construct a full-waveform LiDAR topographic correction model, wherein the random forest regression model uses the canopy waveform parameters and the ground waveform parameters, the LPTI coupling index, and the topographic parameters as independent variables, while the airborne canopy height is used as dependent variables,
S7, obtaining topographically-corrected canopy height by inputting the canopy waveform parameters and the ground waveform parameters extracted from the GEDI footprints, the constructed topographic parameters, and the constructed LPTI coupling index into the full-waveform LiDAR topographic correction model,
wherein the LPTI coupling index constructed in the step S5 is:
$$LPTI = \frac{1}{n} {\sum }_{i = 0} ( sin ( α ) cos ( {θ}_{i} ) tan ( {η}_{i} ) - cos ( α ) )$$
wherein ηᵢ is a slope of the i-th theoretical pixel, θᵢ is a smaller angle between the aspect and a laser azimuth, n is a number of the theoretical pixels, α is a laser elevation angle.

2. The GEDI canopy height correction method considering the twofold influence of the topography according to claim 1, wherein step S1 comprises:
obtaining a latitude range and a longitude range of the target area;
obtaining the airborne canopy height data for the target area;
obtaining the L1B level and the L2A level GEDI LiDAR data within the latitude range and the longitude range of the target area, with a data release time and an airborne canopy height data generation time being in a same year;
obtaining the auxiliary data within the target area, comprising the ALOS DEM data with the spatial resolution of 12.5 m and ESA land cover data with a spatial resolution of 10 m.

3. The GEDI canopy height correction method considering the twofold influence of the topography according to claim 1, wherein step S2 comprises:
performing data filtering on the L1B level and the L2A level GEDI LiDAR data based on footprint quality to remove GEDI footprint data with errors;
performing spatial-scale filtering on the GEDI LiDAR data according to the land cover data to obtain high-quality footprints within the forest area, which specifically comprises: constructing a simulated footprint surface with longitude and latitude contained in the geo-location information of the footprints as the center and a radius of 12.5 m, then by using a forest mask product of a research area as cropping range data, and using simulated footprint vector as to-be-processed data, performing cropping operation, wherein the area represented by each footprint after cropping is the forest area covered by the GEDI footprint; based on a longitude and latitude belt where the research area is located, projecting the cropped footprint vector data by a WGS 1984 ellipsoidal coordinate system to a Gauss-Krüger projection coordinate system of a corresponding indexing belt; and then calculating each footprint vector area in batches, wherein a ratio of the footprint vector area to an area of a circle with an original radius of 12.5 m is a forest cover rate of the footprint, which is calculated as below:
$$FC = \frac{{Area}_{ESA}}{π \times 12 . {5}^{2}}$$
wherein FC is the forest cover rate of the footprint, and Area_{ESA} is the cropped footprint vector area;
after filtering out the GEDI footprints with the forest cover rate lower than a preset rate, extracting footprint numbers of all high-quality forest footprints to form GEDI footprints.

4. The GEDI canopy height correction method considering the twofold influence of the topography according to claim 1, wherein step S3 comprises:
based on numbers of the high-quality footprints of the forest area extracted in step S2, extracting the laser pointing parameters of the screened footprints from the L1B level GEDI LiDAR data, comprising a beam pointing azimuth and a beam pointing elevation angle;
based on the numbers of the high-quality footprints of the forest area extracted in step S2, extracting the geo-location information of the footprints from the L2A level GEDI LiDAR data, comprising a latitude of a lowest detected mode and a longitude of the lowest detected mode; based on the latitude and longitude of the lowest detected mode of the footprints, extracting an average airborne canopy height for each footprint to obtain the footprint-level airborne canopy height;
extracting the canopy waveform parameters from the L1B level and the L2A level GEDI LiDAR data, wherein the canopy waveform parameters specifically comprise: height quantiles and waveform range; extracting the ground waveform parameters from the L2A level GEDI LiDAR data, wherein the ground waveform parameters specifically comprise: an amplitude of the lowest detected mode and an energy of the lowest detected mode.

5. The GEDI canopy height correction method considering the twofold influence of the topography according to claim 4, wherein extracting the canopy waveform parameters from the L1B level and the L2A level GEDI LiDAR data comprises:
performing sampling on the height quantiles rh of the L2A level GEDI LiDAR data and extracting a preset number of height quantile indexes;
extracting parameter indexes for calculating the waveform range from the L1B level GEDI LiDAR data and substituting the parameter indexes into the following formula to calculate the waveform range:
$${W}_{ext} = \frac{botloc - toploc}{rx\_sample \_count} \times ( elevation\_bin0 - elevation\_lastbin )$$
wherein Wₑₓₜ is a waveform range, botloc is an energy index of the lowest detected mode, toploc is an energy index of a highest detected mode, elevation_bin0 is a start elevation of a waveform window, elevation_lastbin is an ending elevation of the waveform window, rx_sample_count is an interval number of waveform sampling.

6. The GEDI canopy height correction method considering the twofold influence of the topography according to claim 1, wherein step S4 comprises:
for the ALOS DEM topographic data with the resolution of 12.5 m, using dynamic window method to construct a calculation window for each pixel, and generating slopes, aspects and roughness of a central pixel and neighboring pixels in the window according to the following formula:
$$Slope = \frac{180}{π} \times arctan ( \sqrt{{( \frac{dh}{dx} )}^{2} + {( \frac{dh}{dy} )}^{2}} )$$
$$Aspect = \frac{180}{π} \times arctan ( \frac{dz / dy}{- dz / dx} )$$
$$Roughness = \sqrt{\frac{\sum H ( j )}{N - 1}}$$
wherein Slope is a slope value of a central point of the window, Aspect is an aspect value of the central point of the window, Roughness is a roughness value of the central point of the window, and dh/dx and dh/dy are elevation change rates of X and Y directions respectively, H(j) is a j-th pixel elevation value within the window, wherein 0<j<4, and N is a number of pixels within the window;
determining coordinates of centers of the four theoretical pixels contained in the footprints based on the position of the center of the GEDI footprints and the projection information contained in the ALOS DEM topographic data with the spatial resolution of 12.5 m; using inverse distance weighting interpolation method to obtain ALOS topographic feature group within GEDI 25 m footprints, and calculating an in-group variance to extract the topographic variability index, based on the following formula:
$${T}_{v ar} = \sqrt{\frac{\sum {( {Slope}_{1} - {Slope}_{avg} )}^{2}}{n}}$$
wherein Slopeᵢ is a slope value of the theoretical pixels, Slope_{avg} is a slope average of the four theoretical pixels corresponding to the footprints, n is a number of the theoretical pixels.

7. The GEDI canopy height correction method considering the twofold influence of the topography according to claim 5, wherein step S6 comprises:
carrying out random sampling in each sub-segment based on a slope distribution; dividing research data into two portions of 80% and 20%, wherein the 80% portion is used as training data and the 20% portion is used as validation data; inputting canopy waveform parameters, ground waveform parameters, topographic parameters, LPTI coupling indexes of the training data as independent variables and the airborne canopy height as dependent variable into the random forest regression model; performing training and parameter optimization on the random forest regression model to obtain the full-waveform LiDAR topographic correction model;
inputting the test data into the full-waveform LiDAR topographic correction model and using an output result as a topographically-corrected GEDI canopy height.

8. The GEDI canopy height correction method considering the twofold influence of the topography according to claim 7, wherein the method further comprises:
using 99% of height quantiles extracted in step S3 as a GEDI canopy height before topographic correction; using linear fitting to calculate relevance, deviation, standard deviation of the GEDI canopy height and the airborne canopy height before and after topographic correction, and further evaluating an availability of the GEDI LiDAR topographic correction model.

9. The GEDI canopy height correction method considering the twofold influence of the topography according to claim 1, wherein the canopy waveform parameters input in step S7 comprises height quantiles and waveform range, and the ground waveform parameters comprise the amplitude of the lowest detected mode and the energy of the lowest detected mode.
